(19) United States
(12) Patent Application Publication
(10) Pub. No.: US 2012/0268953 A1
(43) Pub. Date: Oct. 25, 2012

(54) Lighting Device and Method for Assembling a Lighting Device

(75) Inventors: Nicole Breidenassel, Bad Abbach (DE); Tobias Frost, Burglengenfeld (DE); Guenter Hoetzl, Regensburg (DE); Thomas Preuschl, Sinzing (DE); Peter Sachsenweger, Zeitlarn (DE)

(73) Assignee: OSRAM AG, Munich (DE)

(21) Appl. No.: 13/513,818

(22) PCT Filed: Nov. 15, 2010
(86) PCT No.: PCT/EP2010/067457

§ 371 Date: Jul. 13, 2012

(30) Foreign Application Priority Data
Dec. 4, 2009 (DE) 10 2009 047 520.6

(51) Int. Cl. F21V 29/00; B23P 11/00; F21V 17/18; F21V 17/12; F21V 17/10

(52) U.S. Cl. 362/382; 29/428; 29/525.11

(57) ABSTRACT

A lighting device, comprising a cooling body with at least one receiving area for a printed circuit board in each case, and at least one printed circuit board inserted into the at least one receiving area, with the at least one printed circuit board having a light source on its front face and with at least one part of a rear face making at least thermal contact with the cooling body. The at least one printed circuit board has a rotational locking means in each case which engages with at least one rotational locking mating means of its receiving area.

The invention relates to a lighting device having a cooling body with at least one receiving area for a printed circuit board in each case and at least one printed circuit board inserted into the at least one receiving area, with the at least one printed circuit board having at least one light source on a front face and with at least one part of a rear face being at least in thermal contact with the cooling body. The invention further relates to a method for assembling such a lighting device.

It is known that a printed circuit board equipped on its front face with at least one light emitting diode can be attached by its rear face by means of metallic screws to a cooling body. Thus heat losses generated by the at least one light emitting diode can be transmitted over a large surface area via the rear face to the cooling body. The quality of the heat transmission depends on the thermal contact between the rear face and the cooling body. If the lighting device heats up and thereby the screws as well, the metallic screws can expand so much that the printed circuit board is no longer pressed firmly onto the cooling body but gaps can occur between the two. These gaps however reduce the quality of heat transmission and consequently effectiveness of the heat dissipation. The screws have the further disadvantage of requiring space on the printed circuit board which is no longer able to be used for other components (light emitting diodes, electronic components). In addition the screws give rise to further problems in adherance to creepage distances.

The object of the present invention is to overcome the disadvantages of the prior art at least partly and in particular to provide an especially compact, low-tolerance and less heat-susceptible lighting device.

This object is achieved in accordance with the features of the independent claims. Preferred embodiments can be found in particular in the dependent claims.

The object is achieved by a lighting device having a cooling body with at least one receiving area for a printed circuit board in each case and at least one printed circuit board inserted into the at least one receiving area, with the at least one printed circuit board having at least one light source on a front face and with at least one part of a rear face making at least thermal contact with the cooling body. The at least one printed circuit board features at least one rotational locking means, that is engaged with at least one counter rotational locking means of its receiving area.

The lighting device can thus be assembled in a simple and low-cost manner by turning the cooling body against the printed circuit board. This type of connection is very well suited to allowing for tolerances. The downward pressure required for thermal connection between the cooling body and the printed circuit board is able to be set during assembly via the torque applied independently of mechanical height tolerances. The printed circuit board also does not experience any play in relation to the cooling body when under thermal stress.

Preferably the at least one light source comprises at least one light emitting diode. If a number of light emitting diodes are present, these can illuminate in the same color or in different colors. A color can be monochrome (e.g. red, green, blue etc.) or multichrome (e.g. white). Also the light emitted by the at least one light emitting diode can be an infrared light (IR-LED) or an ultraviolet light (UV-LED). A number of light emitting diodes can generate a mixed light; e.g. a white mixed light. The at least one light emitting diode can contain at least a wavelength-altering luminescent material (conversion LED). The at least one light emitting diode can be present in the form of at least one individually-housed light emitting diode or in the form of at least one LED chip. A number of LED chips can be mounted on a common substrate (sub mount). The at least one light emitting diode can be equipped with at least one own and/or shared optics for beam guidance, e.g. at least one Fresnel lens, collimator and so forth. Instead of or in addition to anorganic light emitting diodes, e.g. based on InGaN or AlInGaP, organic LEDs (OLEDs, e.g. Polymer OLEDs) are also able to be used. Diode lasers can also be used for example. As an alternative the at least one light source can have at least one diode laser for example.

The cooling body can consist of a material with good thermal conductance with λ>10 W/(m·K), e.g. consist of a metal or a ceramic. As an alternative the cooling body can consist of a material with comparatively good thermal conductance with λ>0.2 W/(m˜K) or such a material with a plastic matrix. The at least one printed circuit board has at least one screw fixing means which engages with at least one counter screw fixing means of its receiving area.

The cooling body can for example be manufactured by injection molding, pressing, casting etc.

The front face of the printed circuit board can, in addition to being equipped with the at least one light source, also be equipped with at least one further component, especially an electronic component. At least part of the at least one further component can represent a heat source (e.g. an integrated circuit), the heat of which, for a high level of functional security, is also preferably able to be dissipated to the cooling body.

One embodiment is that the rotational locking means is a screw fixing means and the counter locking means is a counter screw fixing means. In other words the screw fixing means and the counter screw fixing means can be parts of a screw lock. This enables a contact force that becomes continuously greater to be set. As an alternative the rotational locking means and the counter rotational locking means can be parts of a bayonet lock or bayonet-like lock.

A further embodiment is for the at least one printed circuit board to have, at least in some sections, a circular cylindrical circumferential surface and to have on the circular cylindrical structure at least in some sections at least a rotational locking structure, especially a thread structure (thread or structure similar to a thread which acts like a thread) and for the receiving area to have at least one counter rotational locking structure, especially a mating thread structure mating with the rotational locking structure. This embodiment is especially simple to implement and does not occupy any space on the front or rear face of the printed circuit board.

The rotational lock geometry, especially thread geometry, can be inserted for example by rolling, milling or another processing method which removes material. The thread geometry can be coated with a metal in order to increase its ability to resist mechanical stress.

Another embodiment is for the at least one printed circuit board to have a cylindrical circumferential surface in each case and for there to be a thread on said surface with at least one thread pitch and for the receiving area to have a cylindrical circumferential surface and to feature a counter thread which mates with the thread of the circuit board.

Another embodiment is for the at least one circuit board to have an essentially cylindrical circumferential surface in each case and in sections thereon to have a thread with at least one thread pitch and for the receiving area to have a cylindrical circumferential surface and thereon at least in sections a mating thread which matches the thread of the printed circuit board in each case. The sections can for example be like sectors of a circle.

Another embodiment is for the at least one printed circuit board to be held, in particular locked in its receiving area, by at least one securing element. This prevents the printed circuit board being released subsequently. The securing element can be a dedicated securing element, e.g. a securing ring. The securing element can however also be an element which, in addition to its securing function, has at least one further function, e.g. a mechanical function (spacer, lens holder, cover etc.) and/or optical function (reflector, optical waveguide etc.). This saves one component (dedicated securing element).

It is advantageous for the material of the securing element not to be electrically conducting at least in the area of the cooling body, so that air and creepage gaps will not be reduced. Thus a number of components on the printed circuit board can be maintained or even increased while retaining existing space.

Another embodiment is also for the at least one securing element to have at least one rotational locking means which engages with the at least one counter rotational locking means of the receiving area. The securing element can especially be able to be screwed into the counter rotational locking means of the cooling body and for this purpose can have a corresponding outer thread, e.g. on its rear edge. This allows provision of an especially easy-to-implement and low-cost securing.

Another advantageous embodiment for securing the printed circuit board in the cooling body is for the at least one rotational locking means and/or the at least one counter rotational locking means to have at least one latching element. This can be a latching hook or a latching recess for example.

Another advantageous embodiment for securing the printed circuit board in the cooling body is for the at least one rotational locking means and/or the at least one counter rotational locking means to engage with each other by self-locking, e.g. by an applied surface structure, in order to increase frictional force in the screw-lock connection.

Another advantageous embodiment for securing the printed circuit board in the cooling body is for the at least one rotational locking means and/or the at least one counter rotational locking means to be secured by a bonded connection, for example by means of a thread lock adhesive or other adhesive.

Different securing methods can be combined.

Another embodiment is for the at least one printed circuit board to have at least one torque introduction structure. This enables the printed circuit board to be safely and easily held or turned for torsion against the cooling body.

One embodiment is for the at least one torque introduction structure to have at least two through-holes and/or recesses. This is an especially simple and cost-effective embodiment.

The object is also achieved by a method for assembling a lighting device, with the lighting device having a cooling body with at least one receiving area for a printed circuit board in each case as well as at least one printed circuit board inserted into the at least one receiving area, with the at least one printed circuit board having at least one light source on a front face and with at least one part of a rear face being in at least thermal contact with the cooling body. The method features at least the following steps: Inserting the at least one printed circuit board in the associated receiving area by an essentially linear feeding movement; and turning the printed circuit board against the cooling body (by turning the printed circuit board, the cooling body or both elements). The torsion closes a rotational lock which holds the printed circuit board on the cooling body.

A development is that the next step is as follows: Turning, especially screwing, a securing element into the associated receiving area, against the printed circuit board.

The invention is explained schematically in more detail in the following figures which refer to exemplary embodiments. For the sake of clarity the same elements or elements with the same function can be supplied with the same reference characters in the figures.

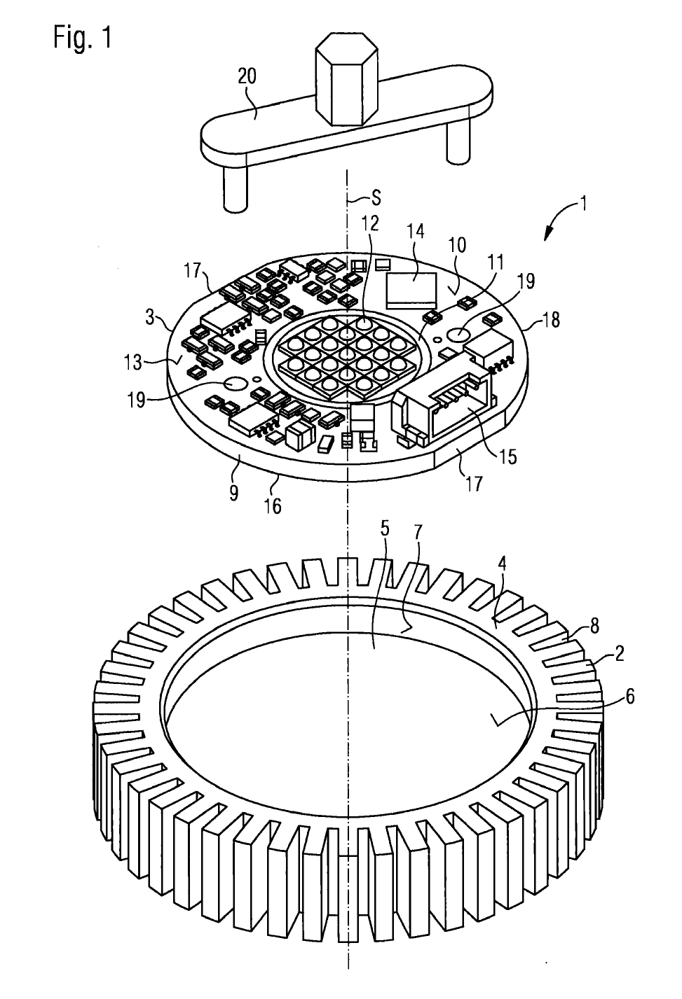

FIG. 1 shows an oblique view from the front of a cooling body and a printed circuit board of a lighting device in accordance with a first embodiment, in a not yet assembled state with an associated torque tool;

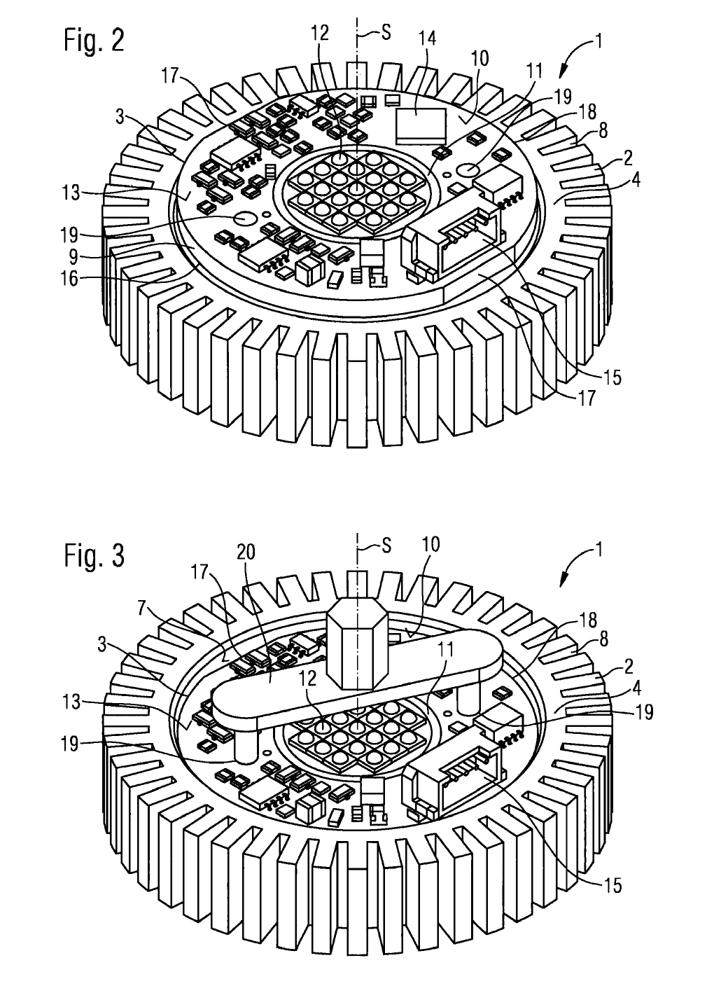

FIG. 2 shows an oblique view from the front of the lighting device according to the first embodiment, with the printed circuit board placed on the cooling body but not yet screwed together with it;

FIG. 3 shows an oblique view from the front of the lighting device according to the first embodiment, with the printed circuit board screwed into the cooling body and with the torque tool not yet inserted;

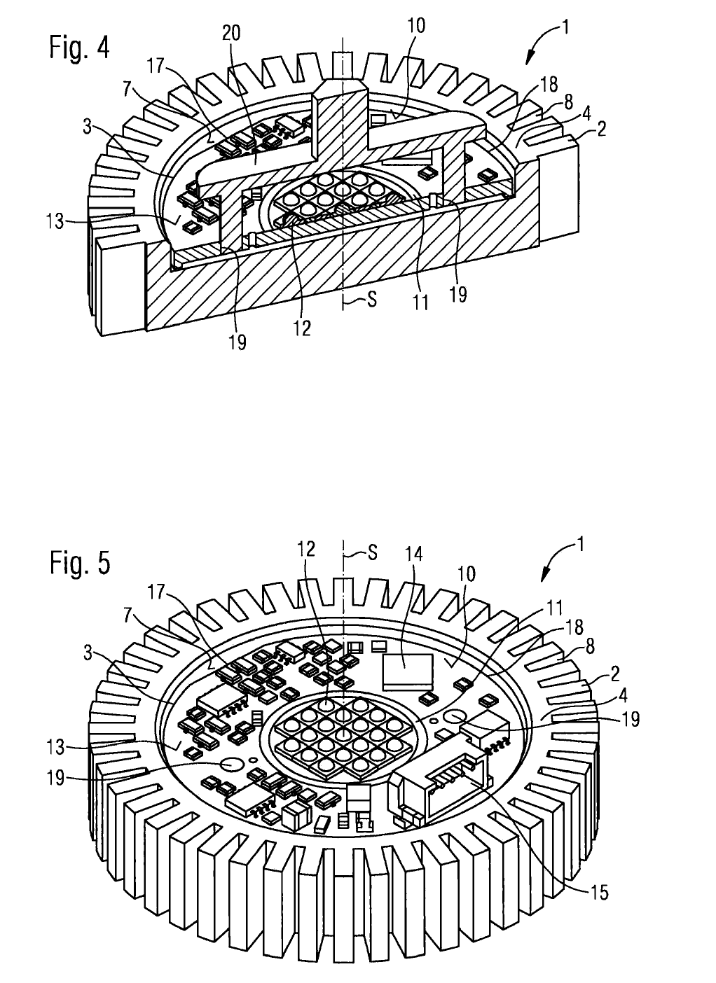

FIG. 4 shows a view similar to that depicted in FIG. 3 of the lighting device according to the first embodiment in a sectional diagram;

FIG. 5 shows an oblique view from the front of the lighting device according to the first embodiment in an assembled state;

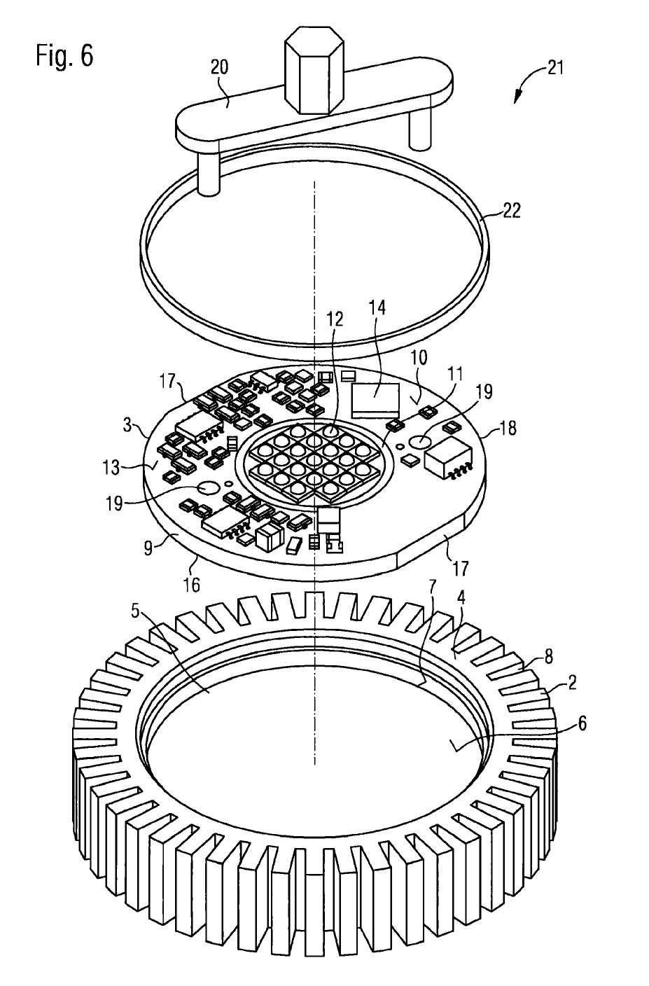

FIG. 6 shows an oblique view from the front of a cooling body, a printed circuit board and a securing element of a lighting device according to a second embodiment in a not yet assembled state with an associated torque tool;

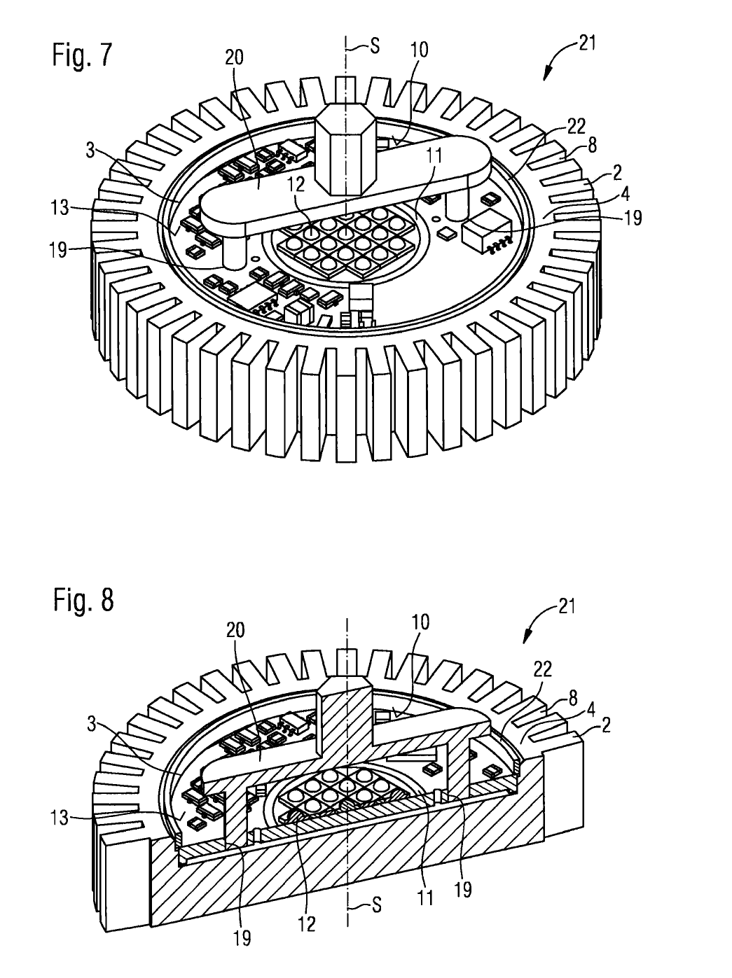

FIG. 7 shows an oblique view from the front of the lighting device according to the second embodiment, with the printed circuit board and the securing element screwed into the cooling body, and with the torque tool still inserted; and

FIG. 8 shows a view similar to that depicted in FIG. 7 of the lighting device according to the second embodiment in a sectional diagram.

FIG. 1 shows a lighting device 1 with a cooling body 2 and a printed circuit board 3 in a not yet assembled state. The cooling body 2 here has a circular disk-type basic shape, with a central cylindrical receiving area 5 being located in its front face side 4. The receiving area 5 has a level base 6 and a lateral edge 7. An outer edge of the cooling body 2 has a collar of cooling ribs 8 radiating outwards.

The printed circuit board 3 has an essentially disk-shaped form with an essentially circular cylinder-shaped circumferential surface 9, with the circumferential surface being flattened off at two opposing straight sections of the circumference 17 and consequently also has two opposing cylindrical circumferential sections 18. A front face 10 of the printed circuit board 3 is equipped in a central circular surface-shaped area 11 with a number of light emitting diodes 12 and in a circular annular area 13 surrounding the circular surface-shaped area 11 is equipped with further components such as electronic components (resistors, capacitors, logic chips 14) or a plug connector 15. The axis of symmetry S running centrally also corresponds in the forwards direction to a main direction of emission or optical axis of the light emitting diodes 12.

For an effective dissipation of heat from the light emitting diodes 12 onto the cooling body 2, a rear face 16 of the printed circuit board 3 is in contact over its full surface with the base 6 of the receiving area 5, if necessary via a TIM (Thermal Interface Material) such as a thermal interface paste or foil. This is done in the present case by the printed circuit board 3 as such being screwed into the cooling body 2 until it presses against the base 6.

For this purpose the printed circuit board 3 has two screw means in the form of a respective (single-pitch or multi-pitch) thread segment (upper diagram), of which one is introduced in each case into a circle cylindrical-shaped circumferential section 18. In other words the printed circuit board 3 can have a screw means in the form of a thread introduced into the essentially circular cylindrical-shaped circumferential surface 9 (upper diagram), which is interrupted by the straight circumferential sections 17. Accordingly a matching thread (upper diagram) is cut into the lateral edge 7 of the receiving area 5, in which the thread of the printed circuit board 3 can be screwed by turning the board. Since the lateral edge 7 of the receiving area 5 is higher than the printed circuit board 3 or its substrate, the mating thread in the lateral edge 7 is higher than the thread on the circumferential surface 9 of the printed circuit board 3.

The thread and the mating thread can be embodied to be self-locking, e.g. by a surface structure and/or at least one latching element. The thread and the mating thread can also be connected to each other by a bonded connection, e.g. via a thread locking adhesive or through a bayonet-type element etc.

To apply a torque to the printed circuit board 3 or to hold the printed circuit board 3 during a rotation of the cooling body 2, the printed circuit board has two insertion holes 19, opposite one another in relation to the axis of symmetry S, in the form of through-holes through the printed circuit board as a torque introduction structure. A torque tool 20 can be inserted into these holes 19, which applies the torque or keeps the printed circuit board 3 still.

For assembling the lighting device, first of all, as shown in FIG. 2, the printed circuit board 3 is inserted on or into the receiving area 5 by an essentially linear feeding movement along the axis of symmetry S. Then the torque tool 20 is inserted into the holes 19, as shown in FIG. 3, and then the printed circuit board 3 is turned by means of the torque tool 20 and in this way screwed into the receiving area 5, as shown in FIG. 4 and FIG. 5.

FIG. 6 shows a view obliquely from the front of a lighting device 21 in accordance with a second embodiment with essentially identical elements to the lighting device 1 of the first embodiment (shown without plug connector 15), with a securing element in the form of a securing ring 22 now being additionally installed. The securing ring 22, as shown in FIG. 7 and FIG. 8, is screwed, after the printed circuit board 3, into the still free part of the (mating) thread in the lateral edge 7 of the receiving area 5 and locks the printed circuit board 3. This provides security against the printed circuit board 3 working loose. By using electrically non-conductive materials (e.g. a plastic) for the securing ring 22 (or generally the securing element) air and creepage gaps are not reduced. The number of components on the printed circuit board 3 can thus be retained or even increased while maintaining the existing space.

Naturally the present invention is not restricted to the exemplary embodiments shown.

Thus the securing element can alternatively be an optical and/or mechanical element (reflector, lens holder, optical waveguide; cover etc.) with a securing function, which has a corresponding outer thread on its lower edge which is able to be screwed into the mating thread in the lateral edge 7 of the receiving area 5.

The cooling body can also have a number of receiving areas.

The form of the cooling body is also not restricted and can purely by way of example also have a rectangular or hexagonal basic surface.

The printed circuit board can for example also have a completely circular outer contour or can have an outer contour with three or more arc-shaped segments.

More than two insertion holes can be used. The insertion holes can also be embodied as recesses in the printed circuit board. The insertion holes can have any given suitable cross-sectional form, e.g. round or angular.

Instead of a screw lock, any other rotary lock can also be used, e.g. a bayonet lock etc.

### LIST OF REFERENCE CHARACTERS

1 Lighting device
2 Cooling body
3 Printed circuit board
4 Front face of the cooling body
5 Receiving area
6 Floor
7 Edge
8 Cooling rib
9 Circumferential surface
10 Front face of the printed circuit board
11 Circular surface area
12 Light emitting diode
13 Circular annular area
14 Logic chip
15 Plug connector
16 Rear face of the printed circuit board
17 Straight circumferential section
18 Circle cylinder-shaped circumferential section
19 Insertion hole
20 Torque tool
21 Lighting device
22 Securing ring

1. A lighting device, comprising:
a cooling body with at least one receiving area for a printed circuit board in each case; and
at least one printed circuit board inserted into the at least one receiving area, with the at least one printed circuit board having a light source on its front face and with at least one part of a rear face making at least thermal contact with the cooling body,
wherein the at least one printed circuit board has a rotational locking means in each case which engages with at least one rotational locking mating means of its receiving area.

2. The lighting device as claimed in claim 1, wherein the rotational locking means is a screw connection means and the counter rotational locking means is a mating screw connection means.

3. The lighting device as claimed in claim 1, wherein
the at least one printed circuit board has a circle cylinder-shaped circumferential surface at least in sections in each case and on the circle cylinder-shaped circumferential surface at least in sections, has at least one rotational locking structure, and
the receiving area has at least one counter rotational locking structure, matching the at least one rotational locking structure.

4. The lighting device as claimed in claim 3, wherein
the at least one printed circuit board has a circle cylinder-shaped circumferential surface in each case and has a thread with at least one thread pitch thereon and,
the receiving area has a circle cylinder-shaped circumferential surface and a mating thread matching the thread of the circuit board thereon.

5. The lighting device as claimed in claim 3, wherein
the at least one printed circuit board has an essentially circle cylinder-shaped circumferential surface and thereon in sections a thread with at least one thread pitch in each case, and
the receiving area has a circle cylinder-shaped circumferential surface and thereon at least in sections a respective mating thread matching the thread of the printed circuit board.

6. The lighting device as claimed in claim 1, wherein the at least one printed circuit board is held in its receiving area by at least one securing element.

7. The lighting device as claimed in claim 6, wherein the at least one securing element has at least one rotational locking means which engages with the at least one counter rotational locking means of the receiving area.

8. The lighting device as claimed in claim 6, wherein the securing element has at least one further function.

9. The lighting device as claimed in claim 1, wherein the at least one rotational locking means and/or the at least one counter rotational locking means have at least one latching element.

10. The lighting device as claimed in claim 1, wherein the at least one rotational locking means and/or the at least one counter rotational locking means are self-locking and/or engage with one another.

11. The lighting device as claimed in claim 1, wherein the at least one rotational locking means and/or the at least one counter rotational locking means are secured by a bonded connection.

12. The lighting device as claimed in claim 1, wherein the at least one printed circuit board has at least one torque introduction structure.

13. The lighting device as claimed in claim 12, wherein the at least one torque introduction structure comprises at least two through-holes and/or recesses.

14. A method for assembling a lighting device, with the lighting device having a cooling body with at least one receiving area for a printed circuit board in each case and also at least one printed circuit board inserted into the at least one receiving area, with the at least one printed circuit board having at least one light source, on its front face and with at least one part of a rear face making at least thermal contact with the cooling body, wherein the method comprises the steps of:
insertion of the at least one printed circuit board into the associated receiving area by an essentially linear feeding movement; and
turning the printed circuit board against the cooling body.

15. The method as claimed in claim 14, further comprising the step of
screwing a securing element into the associated receiving area until it rests against the printed circuit board.

16. The lighting device as claimed in claim 1, wherein said light source is a light emitting diode.

17. The lighting device as claim in claim 3, wherein said locking structure is a thread structure.
